(19) United States
(12) Patent Application Publication
(10) Pub. No.: US 2023/0407023 A1
(43) Pub. Date: Dec. 21, 2023

(54) ION EXCHANGE MEMBRANE AND METHOD OF MANUFACTURING AN ION EXCHANGE MEMBRANE

(71) Applicant: Enapter S.r.l., Pisa (IT)

(72) Inventors: Gabriele AGONIGI, Pisa (IT); Antonio FILPI, Pisa (IT); Stefano CATANORCHI, Pisa (IT); Alessandro MONTI, Pisa (IT); Jan-Justus SCHMIDT, Pisa (IT); Elisa MARTINELLI, Pisa (IT); Giancarlo GALLI, Pescia (IT)

(21) Appl. No.: 18/250,339

(22) PCT Filed: Nov. 1, 2021
(86) PCT No.: PCT/EP2021/080277

§ 371 Date: Apr. 24, 2023

(30) Foreign Application Priority Data
Oct. 30, 2020 (GB) 2017268.0

(51) Int. Cl. C08J 5/22; C08F 287/00; B01J 41/14; B01J 47/12

(52) U.S. Cl. CPC C08J 5/2243; C08F 287/00; B01J 41/14; B01J 47/12; C08J 2355/02; C08F 2438/02

(57) ABSTRACT

A method of manufacturing an anion exchange membrane comprises the following steps: grafting side chains onto a TPE; purifying the grafted TPE; casting the purified grafted TPE; and functionalising the grafted TPE to obtain a cationic moiety. The anion exchange membrane may be used in electrochemical devices including electrolysers, fuel cells or compressors, and is particularly suited to anion exchange membrane electrolysers operating with a dry-cathode.

### FIELD OF THE INVENTION

The present invention relates to an anion exchange membrane (AEM), and a method for manufacturing an AEM. The AEM is intended for, but not necessarily limited to, use in an electrochemical device such as an electrolyser.

### BACKGROUND

Electrolysis of water is well known, having been done since the 1800s. Liquid alkaline and PEM electrolysers are more established, with AEM electrolysers an emerging, more sustainable approach, which is also in an inherently less corrosive environment. However, given the infancy of AEM electrolysis, there are few membranes which satisfy the required properties.

Electrochemical devices may include electrolysers, fuel cells and electrochemical compressors. AEMs may be used with any of those devices. Alternatively, electrochemical devices may use the relatively more established proton exchange membranes (PEM), PEM systems utilising a different reaction pathway.

Ion exchange membranes, either AEM or PEM, are semi-permeable allowing only certain ions to cross from one side to another. In electrochemical devices this tends to be from a cathodic side of the membrane to the anodic side, or vice versa. AEMs allow the transfer of OH⁻ whereas PEMs allowing transport of H⁺ ions. Accordingly, PEMs comprise anions, and AEMs cations in their structure. A further difference is that PEM systems require an acidic environment, which is highly corrosive. A benefit of AEM electrolysers is the ability to use mildly alkaline environments, which are relatively far less corrosive.

The properties desired for an AEM to be used in a device such as an electrolyser are mechanical stability, low hydrogen crossover, low water uptake, and good conductivity.

AEM systems are inherently more sustainable than PEM or Liquid alkaline electrolysers given that AEM systems are not dependent upon platinum group metals (PGM) as catalysts and are less corrosive, allowing usage of cheaper, and/or more sustainable materials for other components.

The defining characteristic of an AEM is the ability to facilitate the transport of anions. Many membranes may achieve this, but consideration must also be given to other characteristics, such as conductivity, durability, water retention and more. Differing methods of manufacturing a membrane with a similar end structure also exist.

### SUMMARY OF THE INVENTION

The object of the present invention is to provide an improved AEM for use with, but not necessarily restricted to, electrochemical devices, and a method of manufacturing said AEM.

According to the present invention there is provided a method of manufacturing an anion exchange membrane comprising the following steps: grafting side chains onto a thermoplastic elastomer (TPE); purifying the grafted TPE; casting the purified grafted TPE; and functionalising the cast grafted TPE to obtain a cationic moiety. For instance, the method of manufacturing an anion exchange membrane may comprise the following steps:
selecting a thermoplastic elastomer (TPE);
synthesising of a statistically controlled radical-grafted TPE;
purifying products, e.g. by removal of undesired side products and reactants;
casting of the radical-grafted TPE film;
quaternization of the radical-grafted TPE film; and
preparing the resultant membrane for use or storage.

Also provided is a membrane comprising a grafted TPE as described herein. The membrane is preferably manufactured using a method of the present invention.

### DETAILED DESCRIPTION

Whilst a variety of TPEs may be used, comprising an aromatic ring or not, in the preferred embodiment a TPE with an aromatic ring such as styrene-butylene-styrene (SBS) is used. Alternatively, the aromatic ring may be styrene, or styrene-like. Styrene-like alternatives do not necessarily need to be derived from styrene, such as polyphenylene oxide (PPO). As used herein, reference to SBS and TPE may be used interchangeably and shall be read as such where appropriate. The TPE selected must be able to undergo a radical grafting reaction.

As used herein styrene-like is intended to mean any aromatic containing units. It is noted that the use of “styrene” is intended to include both styrene, or a styrene-like alternative.

As used herein, radical grafted can refer to any suitable molecule, or monomer, that can be radically grafted and then functionalised, such as by conversion to a quaternary ammonium salt, in the latter steps of the method. In the preferred embodiment vinylbenzyl chloride (VBC) is used. Reference to VBC herein is not intended to exclude other monomers or molecules that may undergo radical grafting.

As used herein statistically controlled refers to the fact that the properties, and preferably the mean length of the grafted polymer chain, can be fine-tuned by the methods defined herein.

An optimal membrane relies upon the balance of two properties: hydrophilicity and hydrophobicity. Hydrophilicity allows good ionic conductivity and exchange whereas hydrophobicity aids the mechanical stability of the membrane. Other properties include gas permeability.

As used herein, quaternization is intended to include amination and the terms may be used interchangeably and interpreted as such.

TPEs are a well-known class of polymers. TPEs are generally copolymers, i.e. they are derived from two or more different types of monomers. It is envisaged that either random copolymers or block copolymers may be used for the TPE. In the preferred embodiment, block copolymers are used.

When the TPE is a block copolymer, it will comprise blocks of first polymer and blocks of second polymer.

The first polymer preferably contains an aromatic group. The first polymer preferably has a hydrocarbon backbone in which alternating carbon centres are attached to an aromatic group, i.e. the first polymer may have the structure —(CH₂CHAr)n— where Ar is an aromatic group. The aromatic ring of the aromatic group is preferably bonded directly to the hydrocarbon backbone, though it could be also be bonded via a linking group such as a C₁₋₅ alkyl group.

The aromatic group preferably comprises a 5- to 10-membered aromatic ring. The aromatic ring may be a heteroaromatic ring (e.g. pyridine or benzoxazole) but is preferably a carbocyclic ring (e.g. benzene or naphthalene). The aromatic group is preferably an optionally-substituted phenyl group. Suitable substituents include C₁₋₅ alkyl groups and halogens (e.g. Cl, Br, I). However, the aromatic group is preferably an unsubstituted phenyl group and, as such, the first polymer is a polystyrene. TPEs which contain styrene blocks are known as styrenic block copolymers (TPE-s).

Though less preferred, other suitable first polymers include polyphenylene oxide, polybutylene terephthalate and polyurethane.

The second polymer is preferably a polymer that can be grafted. For instance, the second polymer may contain a double bond within each repeating unit. The second polymer is preferably a hydrocarbon, i.e. it consists solely of carbon and hydrogen atoms.

The second polymer may comprise, and preferably consists, of C₃₋₁₀ repeating units, preferably C₄₋₈ repeating units, and more preferably C₄₋₆ repeating units. The second polymer may be derived from dienes, and preferably dienes in which the double bonds are conjugated. Suitable dienes include butadienes, pentadienes and hexadienes. Preferred second polymers are derived from butadienes, preferably from 1,3-butadiene, 1,2-butadiene, isoprene, haloprenes (e.g. chloroprene) and mixtures thereof, and more preferably from 1,3-butadiene, 1,2-butadiene and mixtures thereof.

Particularly preferred second polymers are derived from 1,3-butadiene and preferably solely from 1,3-butadiene. As explained in more detail below, 1,3-butadiene can be added to a polymer backbone in a 1,2 (i.e. as —(CH₂—CH(CH₂CH₃))—ₙ-or a 1,4-configuration (i.e. as —(CH₂CH₂CH₂CH₂)—)ₙ. The 1,3-butadiene will typically be added in a predominantly—e.g. greater than 60%, preferably greater than 70%, and more preferably greater than 80%, by weight—1,4 configuration.

The TPE may comprise the first polymer in an amount of at least 20%, preferably at least %, and more preferably at least 30% by weight. The TPE may comprise the first polymer in an amount of up to 60%, preferably up to 50%, and more preferably up to 45% by weight. Thus, the TPE may comprise the first polymer in an amount of from 20 to 60%, preferably from to 50%, and more preferably from 30 to 45% by weight.

The TPE may comprise the second polymer in an amount of at least 40%, preferably at least 50%, and more preferably at least 55% by weight. The TPE may comprise the second polymer in an amount of up to 80%, preferably up to 75%, and more preferably up to 70% by weight. Thus, the TPE may comprise the second polymer in an amount of from 40 to 80%, preferably from 50 to 75%, and more preferably from 55 to 70% by weight.

The TPE may be synthesised using known methods or it may be obtained commercially.

Yet more preferably still the block copolymer is SBS. Block copolymers are preferred as they ensure a relatively high concentration of ionic groups, a requisite for satisfactory ionic conductivity within a membrane. Additionally, the hydrophilic component may microphase to form a region of highly concentrated ionic groups to allow the transfer of anions, and the hydrophobic block may microphase similarly to provide regions of mechanically robust nature even if saturated or in near saturated conditions.

SBS is a preferred TPE as the styrene is hard relative to the butadiene and has a higher glass transition temperature (T g) than butadiene as well.

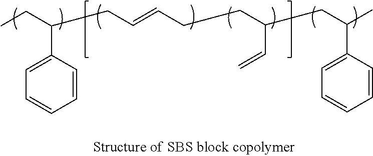

SBS is available commercially with a range of styrene/butadiene content ratios. As well as this there can be a range of 1,2-butadiene/1,4-butadiene content ratios in the SBS polymer. 1,2 and 1,4 represent the atoms in the butadiene monomer that link to the polymer backbone in the SBS rather than the location of the double bonds.

TABLE 1
weight composition of starting SBS.

| | 1,2-butadiene % | 1,4-butadiene % | Styrene % |
|---|---|---|---|
| Sample | wt | wt | wt |
| Solt 6302/G | 10 | 58 | 32 |
| Solt 166 | 9 | 60 | 31 |
| Calprene 501 | 9 | 60 | 31 |
| Calprene 540 | 7 | 54 | 39 |
| Calprene 743x | 7 | 50 | 43 |

It is envisaged that when SBS is used as the TPE the % wt of styrene is between 20% wt and 70% wt. More preferably still between 30% wt and 60% wt.

According to the method of the present invention, side chains are grafted onto the TPE.

In preferred embodiments, a grafting molecule comprising two functional groups is grafted onto the TPE. The first functional group preferably allows for a bond to be formed to the TPE. The second functional group allows for functionalisation into a cationic moiety in a later step.

The first functional group is preferably a double bond, and more preferably is a terminal double bond (i.e. a —CH═CH₂ group). Once grafted, this group takes the form of an ethanediyl group (i.e. a —CH₂—CH₂— group).

The second functional group is preferably a leaving group, such as a halogen (e.g. Cl, Br or I) or a sulfonate (e.g. mesylate or tosylate).

The first and second functional groups are preferably bonded together via a linking group. The linking group may be a C₁₋₅ alkanediyl group, a divalent C₁₋₅ ester, a divalent Ci-5 ether, or an arenediyl group comprising a 5- to 10-membered aromatic ring. Preferably, the linking group is C₁₋₅ alkanediyl group or an arenediyl group, and more preferably the linking group is a benzylene group (i.e. —C₆H₄—CH₂—). In particular, the grafting molecule is preferably a vinyl benzyl group which is bonded to a leaving group (i.e. H₂C═CH—C₆H₄—CH₂-leaving group).

Examples of grafting molecules that can be grafted onto the TPE include halobutenes (e.g. chlorobutene or chloroprene), methacrylate esters (e.g. chlorobutyl methacrylate), and vinylbenzyl halides (e.g. vinylbenzyl chloride (VBC)).

Preferably, the grafting molecule contains at least 4 carbons, more preferably at least 5 carbons, and most preferably at least 6 carbons. Grafting molecules with 4 carbons or less tend to inhibit self-polymerisation. A longer grafted chain may result in a better phase segregation and/or higher charge density thus leading to better conductivity. Particularly preferred as the grafting molecule is VBC. It will be appreciated that these molecules may be referred to as monomers.

The grafting molecule may be grafted onto the TPE alone or together with a spacer monomer. In the latter case, the grafting molecule and the spacer monomer preferably form random copolymer side chains on the TPE. The spacer molecule may be used to change, in particular to dilute, the charge density of the side chains. Thus, the spacer monomer will typically be free from functional groups that are converted into ionic species during the process of the present invention.

The spacer monomer preferably contains an aromatic group. The spacer monomer preferably has a vinyl group attached to an aromatic group, i.e. the spacer monomer may have the structure CH₂═CHAr where Ar is an aromatic group. The aromatic ring of the aromatic group is preferably bonded directly to the vinyl group, though it could be also be bonded via a linking group such as a C₁₋₅ alkyl group.

The aromatic group preferably comprises a 5- to 10-membered aromatic ring. The aromatic ring may be a heteroaromatic ring (e.g. pyridine or benzoxazole) but is preferably a carbocyclic ring (e.g. benzene or naphthalene). The aromatic group is preferably an optionally-substituted phenyl group. Suitable substituents include C₁₋₅ alkyl groups and halogens (e.g. Cl, Br or I). However, the aromatic group is preferably an unsubstituted phenyl group and, as such, the spacer monomer is styrene.

The side chains that are grafted to the TPE may have a number average molar mass, Mn, of at least 5000, preferably at least 7000, and more preferably at least 10000. The side chains that are grafted to the TPE may have a number average molar mass of up to 100000, preferably up to 70000, and more preferably up to 50000. Thus, the side chains that are grafted to the TPE may have a number average molar mass of from 5000 to 100000, preferably from 7000 to 70000, and more preferably from 10000 to 50000.

The side chains are preferably grafted onto the TPE using radical grafting. Thus, where the first step of the method is selecting a TPE, the next stage is the synthesis of radical-grafted TPE conferring functional side chains to the polymeric backbone. The free radical addition preferably occurs on the second polymer, so where the TPE is SBS it occurs on the butadiene units of the SBS system. The formation of the highly reactive radical species is envisaged to occur by one of two pathways, these being: radical activation of the double bonds; and allylic hydrogen abstraction.

It is noted that the reactivity of the two butadiene isomers may be slightly different. Both steric and electronic considerations suggest that double bond in 1,2-butadiene may be more reactive than in the corresponding 1,4-butadiene isomer. The type of radical initiator is also known to affect the reaction pathway. The most prevalent mechanism is understood to function as follows:

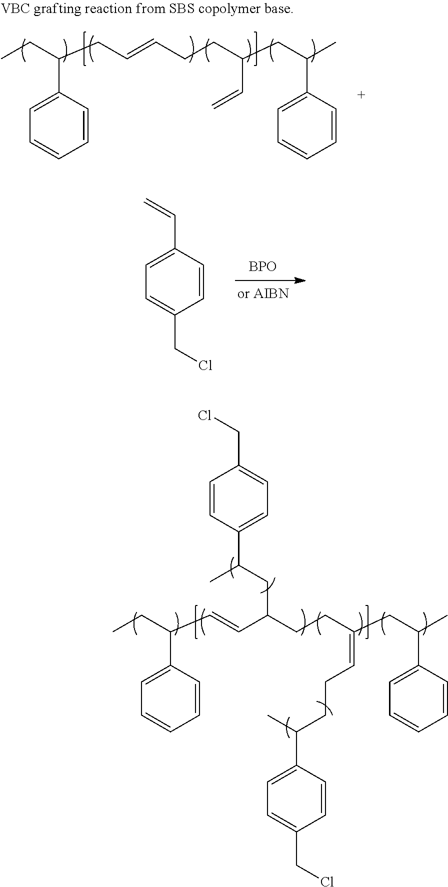

The properties of the final membrane are strongly related to the number, distribution and density of ionic groups present in the membrane. Therefore this stage has a correlation to the final properties as the quaternization/amination permits one ionic group per VBC unit present. By controlling the conditions under which the grating reaction is carried out, a statistically controlled grafted TPE may be prepared.

In the preferred embodiment, a solvent is added. The solvent is intended to dilute the reaction mixture and reduce the radical-initiated side reactions, such as uncontrolled polyaddition of the grafting monomer or molecule. This increases the efficiency and improves the desired properties of the resulting membrane.

Other reaction parameters which can be adjusted to influence the outcome include, but are not necessarily limited to: the stoichiometric ratio of grafting molecule/TPE (e.g. VBC/SBS); the time permitted for the reaction; temperature; and the amount of radical initiator.

The grafting reaction may be carried using a ratio of grafting molecule: TPE of at least 1:1, preferably at least 2:1, and more preferably at least 3:1, by weight. The grafting reaction may be carried using a ratio of grafting molecule: TPE of up to 10:1, preferably up to 8:1, and more preferably up to 5:1, by weight. Thus, the grafting reaction may be carried using a ratio of grafting molecule:TPE of from 1:1 to 10:1, preferably from 2:1 to 8:1, and more preferably from 3:1 to 5:1, by weight.

The molar fraction of grafting molecule, such as VBC, inserted is particularly important because one can assume it as being the functional degree, since the amination reaction that transforms the chloride moiety in ammonium moiety is quantitative. It is envisaged that the mol % of grafting molecule, such as VBC, inserted is in the range of 1% and 50%, more preferably still between 3% and 40%, yet more preferably still between 5% and 30% and most preferably between 9% and 12%. It will be appreciated that mol % represents moles of grafting molecule/(moles of grafting molecule+moles of TPE [i.e. styrene+butadiene where SBS is the TPE]). Where a mixture of different grafting molecules is used, this represents the total mol % of grafting molecules that are added.

Where the grafting molecule is VBC and the TPE is SBS, the weight ratio of VBC:SBS can be in the range of 1:1 and 10:1, or more preferably still between the range of 3:1 and 5:1.

In the preferred embodiment, toluene is the preferred solvent, but other appropriate solvents may be used. For instance, other solvents include dimethylformamide (DMF); dimethyl sulfoxide (DMSO); tetrahydrofuran (THF); organic carbonates such as dimethyl carbonate (DMC), ethylene carbonate and propylene carbonate; hydrocarbon solvents such as benzene, toluene, xylene, durene, cyclopentane, cyclohexane, cycloheptane, cyclooctane, decalin, pentanes, hexanes, heptanes; and mixtures thereof. Preferred solvents are aprotic and, more preferably, contain an aromatic group.

Desired solvent properties include a high boiling point to allow for the reaction to be conducted at temperatures above room temperature, more preferably between 50° C. and 100° C., and more preferably still at approximately 80° C. An alternative method requires higher temperature between 105° C. and 165° C. or more preferably still between 130° C. and 140° C. and yet even more preferably still substantially 135° C. The grafting reaction is preferably carried out at a temperature below the boiling point of the solvent.

The solvent may be used in an amount of at least 1 mL, preferably at least 1.5 mL, and more preferably at least 2 mL, per mmol of grafting molecule. The solvent may be used in an amount of up to 10 mL, preferably up to 5 mL, and more preferably up to 3 mL, per mmol of grafting molecule. Thus, the solvent may be used in an amount of from 1 to 10 mL, preferably from 1.5 to 5 mL, and more preferably from 2 to 3 mL of solvent, per mmol of grafting molecule.

In the preferred embodiment, dibenzoyl peroxide (BPO) is used as the radical initiator. An alternative includes azo initiators such as azobisisobutyronitrile (AIBN), but other free radical initiators may be used. BPO acts mainly as allylic hydrogen abstractor and is preferred to AIBN in order to stimulate the reactivity of 1,4-butadiene units that are more hindered and less reactive toward radical addition.

The duration of the reaction is envisaged as being at least 30 minutes. More preferably still the reaction should be conducted for at least one hour. Yet more preferably still in the range of 1 and 6 hours. Yet even more preferably still in the range of 2 and 5 hours.

As explained in more detail below, radical grafting may also be carried out in the presence of a nitroxide radical-containing compound such as TEMPO. This offers more control over the reaction. In these embodiments, the method of the present invention comprises grafting a nitroxide radical-containing compound onto the TPE preferably using radical grafting, then reacting the radical nitroxide-grafted TPE with the grafting molecule (and optionally a spacer monomer) to form the grafted TPE.

After the grafting reaction, the grafted TPE is preferably precipitated for instance by adding a solvent that causes the grafted TPE to precipitate. Any suitable solvent may be used. Particularly suitable is an acetone:methanol mixture. Preferably the acetone:methanol mixture is substantially 9:1. Alternatively it could be anywhere in the range of 4:1 and 14:1. Solvent amounts and ratios disclosed herein are expressed by volume, as is conventional in the art. The precipitated grafted TPE is preferably separated from the solvent using conventional techniques, such as centrifugation or precipitation.

Where a spacer monomer is used, this can be grafted to the TPE before the grafting molecule. The grafting conditions described above in connection with the grafting monomer may also be applied for the spacer monomer grafting. The spacer monomer-grafted TPE is preferably precipitated e.g. using the conditions described above, optionally purified e.g. using the conditions described below. The grafting molecule may then be grafted to the spacer monomer-grafted TPE.

In other embodiments, the spacer monomer and grafting molecule may be grafted to the TPE at the same time, by conducting the grafting reaction in the presence of both molecules. This method generally provides random copolymer side chains on the TPE.

Irrespective of how it is added, the spacer monomer will typically be used in an amount of at least 1 molar and up to 5 molar equivalents to the grafting molecule.

Following the grafting reaction, the products (i.e. the grafted TPE) must be purified. Purification is typically carried out by removing impurities such as the by-products and unreacted reactants. Preferably, purification is carried out using solvent recrystallisation. This typically gives the polymer in an amorphous form. As such, purification may be seen as carried out using solvent precipitation. The utilisation of a solvent improves over previous methods as filtration is not necessary to remove the insoluble fractions.

Purification may be carried out by dissolving the grafted TPE, along with any impurities, in a first solvent. A second solvent may then be added to precipitate the grafted TPE. Preferably, the impurities remain in solution in the second solvent. The precipitated grafted TPE may then be separated from the solution by conventional methods such as centrifugation or filtration. The dissolving, recrystallising and separation steps may be repeated, e.g. at least twice in total, to provide a higher purity grafted TPE. Different first and second solvents may be used each time the purification steps are repeated.

The separation of the grafted TPE, and particularly where the grafted TPE is VBC-grafted SBS, is preferably achieved by firstly dissolving the reaction mixture in chloroform, or other suitable compound, and precipitating the grafted TPE in a mixture of acetone:methanol. Preferably the acetone:methanol mixture is substantially 9:1. Alternatively it could be anywhere in the range of 4:1 and 14:1. The acetone:methanol mixture facilitates the removal of PVBC by-product and the substantial remainder of unreacted VBC. The second step involves the reaction mixture being dissolved in chloroform and precipitated in methanol. The second step allows the removal of contaminant VBC remaining after the first step.

It is envisaged that as an alternative to acetone:methanol and solvent:non-solvent may be used, and any reference to acetone:methanol is not intended to necessarily exclude alternatives.

The isolation of VBC-grafted SBS was optimized by two successive precipitation steps. In the first one, the reaction mixture was dissolved in chloroform and precipitated in acetone/methanol mixture 9/1, allowing to remove PVBC and the large majority of unreacted VBC. In the second one, the reaction mixture was dissolved in chloroform and precipitated in methanol.

Noted benefits of the present invention are reaction conditions that are milder than those generally used for similar in-bulk modification reactions, in terms of VBC excess, amount of radical initiator and reaction time. The presence of the solvent has a key role in the straightforward downstream procedure, notably in reducing the amount and molecular weight of the non-grafted PVBC. This allows a simpler purification stage, amongst other benefits such as having lower molecular weight of the non-grafted PVBC could lead to shorter polyaddition VBC during the grafting reaction, leading to a lower charge density of the hydrophilic domains and thus, lower water uptake (i.e. better mechanical properties).

Once the grafted TPE has been purified, it is cast. In order to cast the film, the purified grafted TPE, such as VBC-grafted SBS, may be dried. In the preferred embodiment, the purified grafted TPE is dried under vacuum at room temperature, more preferably still the drying occurs in darkened conditions. For the casting of films, portions of the selected polymer were dissolved in a solvent such as chloroform substantially at a ratio of 300 mg/25 mL at room temperature. The cast films are then normally stored in the dark at room temperature.

It is noted that some crosslinking may occur during storage after a few weeks. To prevent those ageing processes, a small amount (20-100 ppm by weight of the solvent) of hydroquinone monomethyl ether may be added to the solvent immediately before casting. Alternatively other radical inhibitors may be added to prevent negatives associated with polymer aging.

It was noted that when the films were not cast immediately after the purification of the polymer, some holes occurred during the subsequent amination process. Thus, casting is preferably conducted less than 1 hour, preferably less than 30 minutes, and more preferably less than 10 minutes after purification. Such issues also were noted when no radical inhibitor chemical, such as hydroquinone monomethyl ether, was present and the polymer stored before amination for a long time. This problem may be attributed to crosslinking. In the preferred embodiment, the solution is filtered, e.g. through filter paper, before casting it in a Teflon Petri dish, or other suitable receptacle. The Petri dishes were left for at least 5 hours, preferably over 8 hours in a fume hood covered by a beaker to control the evaporate rate of the solvent, thereby forming homogeneous films. Preferably the films are between 50-120 μm and more preferably still between 60-100 μm thick.

The next stage is to functionalise the cast grafted TPE, which is usually in the form of a film. This process comprises the formation of a cationic moiety within the radical-grafted TPE. Suitable cationic species may comprise: a quaternary ammonium; a heterocyclic system such as imidazolium; guanidiniums; phosphoniums such as tris(2,4,6-trimethoxyphenyl)phosphonium; sulfoniums such as triarylsulfonium; and metal-based cations. In preferred embodiments, the cationic species is a quaternary ammonium moiety, which may be present in the polymer in the form of a salt. In the preferred embodiment of VBC-grafted SBS films (or other embodiments in which the second functional group is a halide such as a chloride), to convert the chloride group into a quaternary ammonium salt, the cast films are soaked in a solution of preferably methanol or water, other solvents may be used, comprising a tertiary amine, preferably trimethylamine. Alternatively, a monoamine, a diamine, other polyamines or a mixture of the afore mentioned amines may be used. Similar approaches may be used with other leaving groups in the grafting molecule.

The reaction is preferably conducted at temperatures of 40° C. for at least 24 hours, or more preferably over 30 hours, or more preferably still substantially 40 hours or more. The time and temperature correlate to the desired cast film thickness, and the amine(s) used in the process. The reaction should be completed in a controlled environment including closed flask, such as an Erlenmeyer flask. This may be scaled as appropriate.

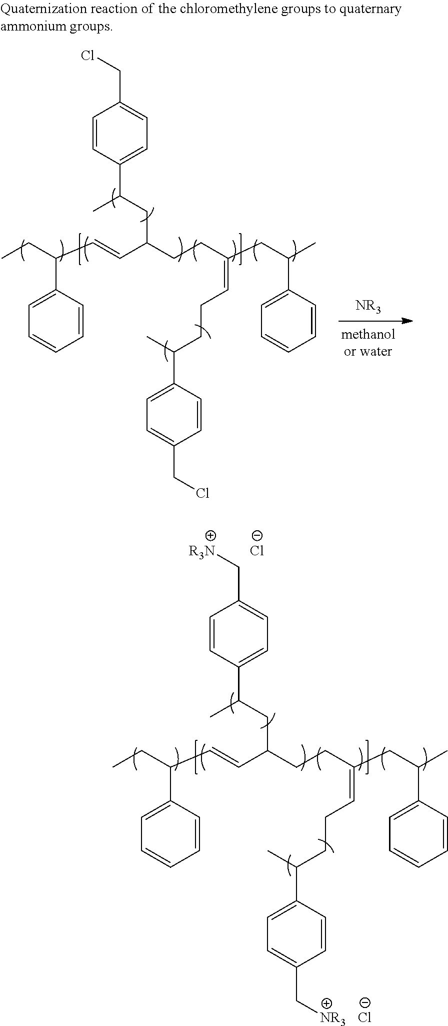

Upon completion of the reaction, the films may be washed repeatedly with water and methanol and then dried under vacuum at room temperature and stored in the dark at substantially 4° C. in anticipation of use or storage.

Whilst the membrane may be used in any scenario requiring an AEM, the preferred application is electrochemical devices including electrolysers, fuel cells or compressors. Most preferably the AEM will be used with an AEM electrolyser operating with a dry-cathode.

According to another embodiment of the present invention there is provided another means for obtaining a radical-grafted TPE comprising the following steps:
selecting a thermoplastic elastomer (TPE);
synthesis of radical nitroxide-grafted TPE;
reacting radical nitroxide-grafted TPE with VBC
purifying products/removal of undesired products and reactants from VBC-grafted TPE.

The resultant radical-grafted TPE may then be treated in accordance with the above methods before use. This method is referred to as controlled radical polymerization herein.

As above, the preferred TPE is SBS, and as used herein may be used interchangeably, although other TPEs with or without an aromatic ring may be suitable.

Free-radical grafting polymerization as described above is one manner with a variety of methods to graft polymer side chain onto a main backbone. SBS copolymers can be easily functionalized in this way, owing to the reactivity of the double bonds of the butadiene units. Even if the addition of a solvent to the reaction system reduces the amount of free PVBC and its molecular weight, it is very hard to completely eliminate its formation and to control the number of grafting sites along the main chain as well as the length of the PVBC grafts by varying the experimental conditions. Other benefits are conferred such as having lower molecular weight of the non-grafted PVBC could lead to shorter polyaddition VBC during the grafting reaction, leading to a lower charge density of the hydrophilic domains and thus, lower water uptake (i.e. better mechanical properties)

An alternative approach described herein consists of using a nitroxide-mediated polymerization reaction, which allows to better control the growth of the polymer graft side-chains on account of the reduction of the concentration of macroradical growing species by trapping them with an added non-propagating radical species, such as a 2,2,6,6-tetramethylpiperidine 1-oxyl (TEMPO) nitroxide radical.′TEMPO is the parent member of a large family of radical nitroxides synthesized in recent years, as such alternative may be used from within this family. Several functional groups may be inserted to modulate the selectivity and the activation temperature of the derived alkoxyamine bond. In the preferred embodiment TEMPO is selected as the most common, commercially available candidate. As used herein TEMPO-grafted may be used to refer to any nitroxide mediated controlled grafting and is not necessarily limited to TEMPO only.

The mechanism relies on the thermal reversibility of the alkoxyamine bond which forms when the nitroxide free radical encounters other carbon-centred radicals. The nitroxide radical scavenges the growing chain end and lowers the concentration of propagating radical species, thus reducing the undesired termination reactions. By increasing temperature, the alkoxyamine bond becomes labile and the two, active and dormant, forms rapidly interconvert as seen below.

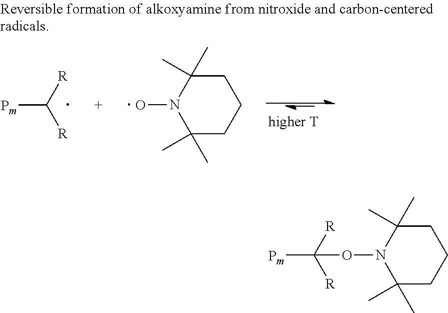

Estimating the amount of′TEMPO that can be inserted on the SBS backbone, since only the units functionalized with the nitroxide will be active as propagating radicals in the subsequent grafting reaction with VBC, shown below.

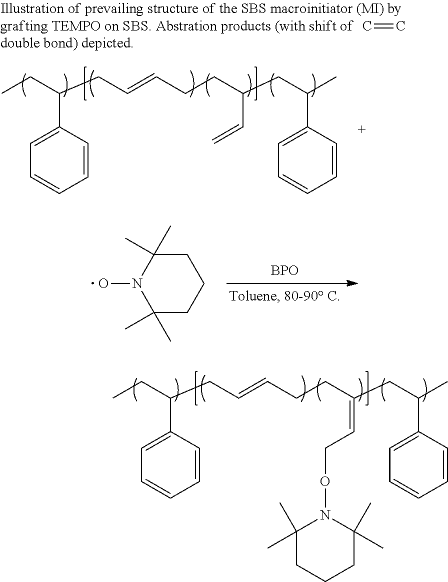

In the preferred embodiment, the functionalization of the SBS copolymer with TEMPO was conducted in toluene using BPO as a radical initiator. Alternative TPEs, solvents and radical initiators may be used as discussed above.

In the preferred embodiment the reaction is conducted between 70° C. and 90° C., more preferably still at substantially 80° C. However, it is also envisaged that the reaction may be done in the range of 50° C. to 120° C.

Whilst the reaction may be done for an hour, preferably it is done for at least 3 hours. More preferably still between 12 and 84 hours, yet more preferably still between 24 and 72 hours.

Following the reaction, the mixture was purified by at least one precipitation of the TEMPO-grafted SBS in chloroform solution with acetone:methanol, the ratio of acetone:methanol in the ratios stated above. Preferably there are at least 2 repetitions, and more preferably 3 to ensure purity of the product.

As discussed above, it is envisaged that as an alternative to acetone:methanol and solvent:non-solvent may be used. reference to acetone:methanol is not intended to necessarily exclude alternatives.

The TEMPO-grafted TPE, being a macroinitiator, can then be reacted with a grafting molecule, such as VBC, to obtain a grafted TPE such as VBC-grafted SBS. In the preferred embodiment, insertion of VBC is achieved by using a solvent to create a solution of the TEMPO-grafted SBS and VBC, the solution then being heated. Ideally the solution is heated to substantially 130° C., it is envisaged that anywhere between 100° C. and 160° C. may be suitable. At such a temperature the alkoxyamine bond becomes labile, thereby permitting initiation and propagation of VBC grafts. The main advantage of this synthetic protocol is that no further radical initiator is needed, thus reducing the rate of homopolymerization of VBC. Indeed, no evidence of formation of PVBC was observed. Insertion of substantially 30 wt % VBC was achieved in the final product, however it is envisaged that the mol % of VBC inserted is in the range of 1% and 50%, more preferably still between 3% and 40%, yet more preferably still between 5% and 30% and most preferably between 7% and 12%.

The reaction can be done for varied amounts of time, in the range of 3 hours to 72 hours, or more preferably 6 hours to 64 hours.

As mentioned above, in a variant of the present invention a random co-polymer side chain, diluting the charge density with a spacer monomer such as styrene or styrene-like compound, can be achieved. The IEMPO-grafted SBS is dissolved in a solvent such as toluene preferably at room temperature. Alternatively it may be done at elevated temperatures, not exceeding the boiling point of the solvent. Once dissolved VBC or a suitable alternative thereof may be added with styrene. Alternatives to styrene include any monomer which may undergo radical polymerization, or other radical grafting monomer that can act as a spacer i.e. that is not converted to contain a cationic species in later stages. The mixture is then heated to between 105° C. and 165° C., or more preferably substantially 135° C. for over 1 hour, preferably 5 hours. Toluene or another solvent is then added and the mixture precipitated in an acetone:methanol mixture, or alternative as discussed at other stages. The precipitate is then separated, preferably by centrifugation and again dissolved in chloroform or alternative solvent before being precipitated in methanol or other non-solvent that promotes polymer precipitation. This step can be repeated for a second, or third time or more to obtain a pure VBC-co-Styrene-grafted SBS. For the avoidance of doubt, VBC includes any monomer which may be converted to acationic species, and styrene alternatives include any spacer.

In another variant of the present invention, the TEMPO-grafted SBS is again dissolved in a solvent such as toluene preferably at room temperature, but may be done at higher temperatures as discussed above. Once dissolved styrene, or spacer equivalent, is added and the mixture is then heated to between 105° C. and 165° C., or more preferably substantially 135° C. for over 1 hour, preferably 5 hours. The styrene or equivalent used herein should not carry any ionic moieties but may affect mechanical properties as well as distancing the ionic part far apart the main polymer chain. The monomer inserted in this phase may be any chemical that may react through radical polymerization. Toluene or another solvent is then added and the mixture precipitated in an acetone:methanol mixture as discussed at other stages. The precipitate is then separated, preferably by centrifugation and again dissolved in chloroform or alternative solvent before being precipitated in methanol.

At this point, instead of repeating as above, the precipitate is dissolved in a solvent such as toluene, and VBC or equivalent added before heating to between 105° C. and 165° C., or more preferably substantially 135° C. for over 1 hour, preferably 5 hours. The purification step is then repeated as above to obtain a substantially pure VBC-co-Sty-grafted SBS.

The above variants aid in the tuning of the charge density, spacing said charges either randomly or in a predictable block manner. It is envisaged that the above processes may be repeated to add more spacers, thereby further finetuning the properties of the final membrane.

Different steps may be taken to vary the final product, these including, but not necessarily limited to: reaction time; concentration of reactants; temperature; amount of VBC; feed VBC/TEMPO mole ratio; in the grafting reaction in order to modulate VBC insertion.

The controlled radical grafting approach surprisingly was able to achieve a comparable amount of VBC, thereby allowing for the manufacture of a membrane with similar degrees of functionalisation as achieved in the products obtained by conventional radical grafting.

According to the invention there is provided an anion exchange membrane made in accordance with the above methods, the membrane comprising:
a thermoplastic elastomer (TPE) said TPE being a polymeric backbone, wherein
the polymeric backbone is functionalised, preferably by 4-benzylammonium moieties:

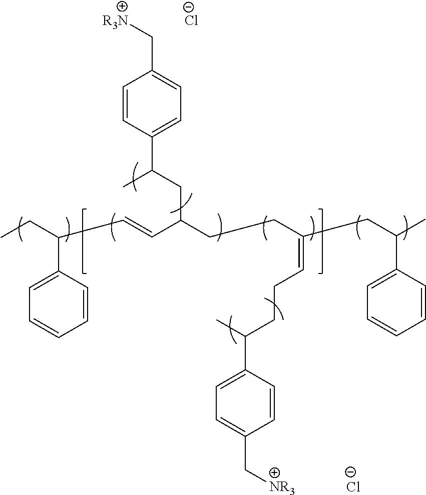

An optimal membrane relies upon the balance of multiple properties including: hydrophilicity and hydrophobicity. Hydrophilicity allows good ionic conductivity and exchange whereas hydrophobicity aids the mechanical stability of the membrane. Other properties include gas permeability, this allows for a purer product in embodiments wherein hydrogen is generated at pressure in an AEM electrolyser, it also reduces the mixed potential in an AEM fuel cell.

It is envisaged that either random copolymers or block copolymers may be used for the TPE. In the preferred embodiment, block copolymers are used. Yet more preferably still the block copolymer is SBS. Block copolymers are preferred as they promote nanophase separation between the hydrophylic and hydrophobic phases, thus allowing for less tortuous pathways between ion-conducting channels. This helps ensure a relatively high concentration of ionic groups, a requisite for satisfactory ionic conductivity within a membrane.

The invention is not intended to be restricted to the details of the above-described embodiment. For instance, alternative reactants, solvents or other compounds may be used which are not known today or described herein, without deviating from the inventive aspect.

The scales discussed herein are lab-scale, but it is envisaged that the production may be scaled up. Scaling may impact the time or require amendments to the method such as stirring not disclosed herein. Additionally, the cast membranes may be cut to size, or cast to size.

### Examples

### Example 1—Preparation of a VBC-Grafted SBS Copolymer

Commercial SBS copolymer (2.025 g) was dissolved at room temperature in toluene (10 mL). After a clear solution was obtained, VBC (5.6 mL, 39.7 mmol) and BPO (53 mg, 0.22 mmol) were added to the solution and the mixture was heated at 80° C. After 2 hours, the heating was stopped and chloroform (20 mL) was added. The mixture was then precipitated in acetone/methanol (9/1 v/v, 400 mL) obtaining a whitish precipitate that has been recovered after centrifugation. The solid residue was then dissolved again in chloroform (20 mL). The solution was slowly dropped in methanol (200 mL) to obtain pure VBC-grafted SBS (2.120 g)

### Example 2—Casting a VBC-Grafted TPE

VBC-grafted TPE (340 mg) was dissolved in toluene (25 mL) at ambient temperature. After filtration on filter paper, a few drops of a chloroform solution of hydroquinone monomethyl ether (0.15 mL of a 125 mg/L solution) were added under stirring. The clear solution was sonicated for 5 minutes and then poured into a glass Petri dish (7 cm diameter). The Petri dish was left overnight inside the fume hood covered by a beaker to slowly evaporate the solvent.

### Example 3—Quaternization

In an Erlenmeyer flask an aqueous solution of trimethylamine (6 mL, 45% w/v) was added to methanol (100 mL) to obtain a 2.5% w/v solution. VBC-grafted TPE films were immersed in the solution and heated for 40 hours at 40° C. The films were then washed repeatedly with water and methanol and dried under vacuum at room temperature. The reactions were proven to be completed by the disappearance of the IR absorption band at 1265 cm⁻¹.

### Example 4—Properties of an Anion Exchange Membrane (AEM)

The AEM that was obtained following Example 3 exhibited the following properties that make it highly suited for use in an electrolyser:
conductivity (OH form) of 32.85 mS/cm⁻¹ at room temperature;
water uptake of 92%; and
IEC of 0.97 meq g⁻¹.

1. A method of manufacturing an anion exchange membrane comprising the following steps:
grafting side chains onto a thermoplastic elastomer (TPE);
purifying the grafted TPE;
casting the purified grafted TPE; and
functionalising the grafted TPE to obtain a cationic moiety.

2. A method of manufacturing an anion exchange membrane as claimed in claim 1, comprising the following steps:
selecting a TPE;
synthesising of a statistically controlled radical-grafted TPE;
purifying products, e.g. by removal of undesired side products and reactants;
casting of the radical-grafted TPE film;
quaternization of the radical-grafted TPE film; and
preparing the resultant membrane for use or storage.

3. A method of manufacturing an anion exchange membrane as claimed in claim 1, wherein the TPE is styrene-butylene-styrene (SBS).

4. A method of manufacturing an anion exchange membrane as claimed in claim 1, wherein the TPE is any one of a: random copolymer and a block co-polymer, and is preferably a block co-polymer.

5. A method of manufacturing an anion exchange membrane as claimed in claim 1, wherein SBS is the TPE, and the % wt of styrene is between 20% and 70%.

6. A method of manufacturing an anion exchange membrane as claimed in claim 1, wherein the grafting molecule or monomer contains at least 4 carbon atoms, preferably at least 5 carbon atoms, and more preferably at least 6 carbon atoms.

7. A method of manufacturing an anion exchange membrane as claimed in claim 1, wherein the grafting molecule or monomer suitable for of the radical grafting is VBC.

8. A method of manufacturing an anion exchange membrane as claimed in claim 1, wherein the grafting molecule is grafted onto the TPE alone or together with a spacer monomer.

9. A method of manufacturing an anion exchange membrane as claimed in claim 1, wherein the synthesising of the radical grafted TPE comprises adding a solvent and heating the mixture between 50° C. and 165° C.

10. A method of manufacturing an anion exchange membrane as claimed in claim 1, wherein the synthesising of the radical grafted TPE further comprises introducing a radical initiator, said radical initiator preferably being any one of: BPO and AIBN.

11. A method of manufacturing an anion exchange membrane as claimed in claim 1, wherein the purification of the radical grafted TPE comprises dissolving the impure mixture and precipitating the VBC-grafted SBS in a solution of solvent:non-solvent.

12. A method of manufacturing an anion exchange membrane as claimed in claim 11 wherein the solvent:non-solvent is acetone:methanol.

13. A method of manufacturing an anion exchange membrane as claimed in claim 11, wherein the purification step is repeated at least two times.

14. A method of manufacturing an anion exchange membrane as claimed in claim 11, wherein the solvent:non-solvent is in a ratio of 9:1.

15. A method of manufacturing an anion exchange membrane as claimed in claim 1, wherein the VBC or equivalent is between 5% mol and 30% mol of the radical-grafted TPE.

16. A method of manufacturing an anion exchange membrane as claimed in claim 1, wherein the membrane casting comprises drying the purified VBC-grafted SBS under vacuum in darkened conditions.

17. A method of manufacturing an anion exchange membrane as claimed in claim 1, wherein a radical inhibitor is added to the polymer before amination.

18. A method of manufacturing an anion exchange membrane as claimed in claim 1, wherein the amination comprises soaking the cast film in a solvent comprising one or more amines.

19. A method of manufacturing an anion exchange membrane as claimed in claim 1, wherein a radical-grafted TPE is obtained by:
selecting a thermoplastic elastomer (TPE);
synthesis of radical nitroxide-grafted TPE;
reacting radical nitroxides-grafted TPE with VBC, or equivalent.

20. A method of manufacturing an anion exchange membrane as claimed in claim 19 wherein the nitroxide radical is TEMPO.

21. A method of manufacturing an anion exchange membrane as claimed in claim 19, wherein TPE and nitroxide radical are reacted in a solution of toluene with BPO.

22. A method of manufacturing an anion exchange membrane as claimed in claim 19, wherein the reaction occurs between 70° C. and 90° C.

23. A method of manufacturing an anion exchange membrane as claimed in claim 19, wherein the nitroxide radical grafted TPE is reacted with VBC in a solvent between 100° C. and 160° C.

24. A method of manufacturing an anion exchange membrane as claimed in claim 1, wherein spacers are added by the nitroxide radical-grafted TPE being:
dissolved in a solvent,
VBC added with styrene to the solution,
precipitating the solution after heating in a solvent:non-solvent mixture, and
separating the precipitate for purification.

25. A membrane manufactured in accordance with the method of claim 1.
